(19) United States
(12) Patent Application Publication
(10) Pub. No.: US 2004/0185391 A1
(43) Pub. Date: Sep. 23, 2004

(54) Silver halide color photographic light sensitive material for image capture and color image forming method

(75) Inventors: Masaru Iwagaki, Tokyo (JP); Tsukasa Ito, Tokyo (JP)

Correspondence Address: Finnegan, Henderson, Farabow,, Garrett & Dunner, L.L.P., 1300 I Street, N.W., Washington, DC, 20005-3315, US

(73) Assignee: KONICA MINOLTA HOLDINGS, INC.

(21) Appl. No.: 10/792,816

(22) Filed: Mar. 5, 2004

(30) Foreign Application Priority Data
Mar. 10, 2003 (JP) JP2003-062999

(51) Int. Cl. G03C 1/08

(52) U.S. Cl. 430/505; 430/506; 430/544

(57) ABSTRACT

A silver halide color photographic light sensitive material for image capture comprising a transparent substrate having on one surface side thereof, a red light-sensitive layer unit, a green light-sensitive layer unit and a blue light-sensitive layer unit, each light-sensitive layer unit having at least 2 layers of the same spectral sensitivity having a different light sensitivity, and a specific photographic sensitivity of the light sensitive material is 50 or more,

wherein the light sensitive material produces an image after being exposed and being subjected to a development processing, each color image formed in the red sensitive layer unit, the green sensitive layer unit or the blue sensitive layer unit exhibits +0.05 or more secondary differential values in a region of more than 70% of a principal gradation portion in each characteristic curve of red, green and blue, and each transmission minimum density value of red light, green light and blue light is 0.15 or less.

### TECHNICAL FIELD

The present invention relates to a silver halide color photographic light sensitive material (hereafter, also referred to as a photographic material) for image capture and a color image forming method, and in particular to a silver halide color photographic material for image capture which is easily read with a scanner and easily converted to digital image information, and to a color image forming method to obtain high quality color images.

### BACKGROUND

Heretofore, as a photographic material for image capture to obtain color prints, mainly employed has been color negative film. Widely employed is a nega-posi photographic system which comprises the steps of development of a color negative film after exposure and then printing the obtained color image onto color print paper to obtain a color print.

With this system, it is possible to obtain extremely high quality prints. On the other hand, since it requires development processing of photographic color paper, in addition to that of a color negative film, to obtain color prints from a color negative film after image capture, many processes and much time are required. Thus, the system has major drawbacks of not only lacking speed but also requiring a color paper development process.

In the meantime, digital still cameras, which have gotten a lot of attention recently, capture visual information which is recorded as digital information, and thus, it is possible to obtain a color hard copy (such as a color print and an ink-jet print) of the image within a few minutes with any appropriate means after image capture. However, the present situation is that quality of these prints obtained using a general digital still camera is very unsatisfactory compared to that of conventional color prints.

Consequently, required is development of a system which can provide digitized image information and high quality color prints in a short amount of time, using a silver halide color photographic light sensitive material for image capture and avoiding photographic color print paper.

As methods to read image information using a scanner after development of a silver halide color photographic material for image capture, commonly known are the methods described in unexamined Japanese Patent Application Publication (hereinafter, referred to as JP-A) Nos. 5-100321, 9-121265, 9-146247,9-230557, 9-281675, 11-52526, 11-52527, 11-52528 and 11-65051, and U.S. Pat. Nos. 5,101,286, 5,113,351, 5,627,016 and 5,840,470. However, these methods are not sufficient in terms of stability and speed of development processing, and production of waste material such as a processing sheet.

At the same time, various proposals have been made regarding gradation characteristics and spectral sensitivity characteristics of silver halide color photographic light sensitive materials for image capture. For example, proposed is a silver halide color photographic material the straight line gradient of which is determined by the least square method from the primary differential values of the characteristic curves of each of a red sensitive layer, a green sensitive layer and a blue sensitive layer within a certain range; and the relationship of sensitivities of the green sensitive silver halide emulsion layer and the red sensitive silver halide emulsion layer is set within a specific condition; and the sensitivities of which are determined with uniform exposure by white light and with a single 560 nm color light; resulting in no quality deterioration after printing, specifically when using fluorescent lamps. (For example, refer to Patent Document 1.) Further, proposed is a silver halide color photographic material which provides a satisfactory quality print when image capture is performed under various regions of brightness from cloudy day light to clear bright weather, under the condition of more than 0.4 in point gamma (d D/d Log E) of density function curves D (Log E) of all of blue, green and red are provided at more than 2.8 in Log E. (Refer, for example, to Patent Document 2.) However, in recent years neither method has exhibited sufficient desired effects of preparation of a color print by reading image information using a color scanner.

Further, in cases when a typical silver halide color photographic material for image capture is employed as a material for scanner reading, since it is essentially designed for use in printing onto color print paper, colored couplers for masking and dyes for adjusting the minimum densities affect to reduce the S/N ratio during reading, and when the exposure conditions during image capture are either under or over exposure, the photographic material is said to not necessarily have sufficient reading capability, resulting in the present situation of not exhibiting enough advantages as a system. Specifically, deterioration of graininess (a matter of being grainy or rough) in highlighted areas (being high density areas in color negative film) and loss of gradation (being block or plug) in shadow areas (being low density areas in color negative film) tend to occur, resulting in significant image defects when using low priced general purpose scanners which tend to feature low resolution.

Patent Document 1: JP-A 5-72683 (Claims)

Patent Document 2: JP-A 6-258787 (Claims)

Consequently, an object of the present invention is to provide a silver halide color photographic light sensitive material for image capture which is superior in image reading capability using a general purpose scanner, after which the read image information is easily converted to digital data, resulting in high quality color prints, and another object is to provide a color image forming method by which excellent color images can be formed, exhibiting sufficient performance on silver halide photographic material for image capture.

### SUMMARY

The above object of the present invention can be accomplished by the following constitutions.

1. A silver halide color photographic light sensitive material for image capture comprising a transparent substrate having on one surface thereof, a red light-sensitive layer unit, a green light-sensitive layer unit and a blue light-sensitive layer unit, each light-sensitive layer unit having at least 2 layers of the same spectral sensitivity having a different light sensitivity, and a specific photographic sensitivity of the light sensitive material is 50 or more,

wherein the light sensitive material produces an image after being exposed and being subjected to a development processing, each color image formed in the red sensitive layer unit, the green sensitive layer unit or the blue sensitive layer unit exhibits +0.05 or more secondary differential values in a region of more than 70% of a principal gradation portion in each characteristic curve of red, green and blue, and each minimum transparent density value of red light, green light and blue light is 0.15 or less.

2. The silver halide color photographic light sensitive material for image capture comprising a transparent substrate having on one surface thereof, a red light-sensitive layer unit, a green light-sensitive layer unit and a blue light-sensitive layer unit, each light-sensitive layer unit having at least 2 layers of the same spectral sensitivity having a different light sensitivity, and a specific photographic sensitivity of the light sensitive material is 50 or more,

wherein the light sensitive material produces an image after being exposed and being subjected to a development processing, each color image formed in the red sensitive layer unit, the green sensitive layer unit and the blue sensitive layer unit exhibits +0.05 or more secondary differential values in more than 70% of a region of a principal gradation portion in each characteristic curve, and color separation exposure gradations of γR, γG and γB and white light exposure gradation of γWR, γWG and γWB fulfill all of the following formulas (1) to (3):

1.0≦γR/γWR≦1.05 Formula (1)

1.0≦γG/γWG≦1.05 Formula (2)

1.0≦γB/γWB≦1.05 Formula (3)

wherein γR, γG and γB are each red sensitive layer gradation at red light exposure, green sensitive layer gradation at green light exposure and blue sensitive layer gradation at blue light exposure respectively; γWR, γWG and γWB are each red sensitive layer gradation at white light exposure, green sensitive layer gradation at white light exposure and blue sensitive layer gradation at white light exposure respectively.

3. The silver halide color photographic light sensitive material for image capture comprising a transparent substrate having on one surface thereof, a red light-sensitive layer unit, a green light-sensitive layer unit and a blue light-sensitive layer unit, each light-sensitive layer unit having at least 2 layers of the same spectral sensitivity having a different light sensitivity, and a specific photographic sensitivity of the light sensitive material is 50 or more,

wherein the light sensitive material produces an image after being exposed and being subjected to a development processing, each color image formed in the red sensitive layer unit, the green sensitive layer unit and the blue sensitive layer unit exhibits a standard deviation σ of 0.01-0.05 obtained from exponential function matching in more than 70% of a region of a principal gradation portion in each characteristic curve of red light, green light and blue light.

4. A color image forming method for obtaining color prints from outputted digital images after the silver halide color photographic light sensitive material for image capture has been exposed and development processed, followed by digital image conversion,

wherein the light sensitive material produces an image after being exposed and being subjected to a development processing, each color image formed in the red sensitive layer unit, the green sensitive layer unit or the blue sensitive layer unit exhibits positive secondary differential values in not less than 70% of the region of the principal gradation portion in the characteristic curves, and digital image data conversion is conducted using a method comprising the steps of:

(i) providing shading correction, pixel sensitivity correction and dark current correction to the outputted signals in proportion to an amount of transmitted light, and

(ii) converting the corrected signals to signals in proportion to image luminance using nonlinear conversion.

The image produced after being exposed and being subjected to a development processing comprises a color image formed in the red sensitive layer unit, a color image formed in the green sensitive layer unit and a color image formed in the blue sensitive layer unit.

### BRIEF DESCRIPTION OF THE DRAWINGS

FIG. 1: a conceptual diagram showing details of the standard deviation of exponential function matching of the present invention

In the present invention, the inventors found a silver halide color photographic light sensitive material for image capture which is superior in image reading capability using a general purpose scanner, and the read image information is easily converted to digital data, and obtained color prints from which is high quality, and are offering this invention. The silver halide color photographic light sensitive material for image capture comprises a transparent substrate, a red light sensitive layer unit, a green light sensitive layer unit and a blue light sensitive layer unit thereon, all units of which have at least two layers of the same spectral sensitivity but different light sensitivity, exhibiting characteristics of:

a. all of the color images formed from the red, green and blue sensitive layer units, having +0.05 or more secondary differential values in more than 70% of the region of the principal gradation portion in the characteristic curves, and the transparent minimum density values are 0.15 or less

b. color separation exposure gradations of γR, γG and γB and white light exposure gradation of γWR, γWG and γWB fulfill all the relationships of foregoing Equations (1)-(3), and specific photographic sensitivity is 50 or more or

c. all of the color images formed from the red, green and blue sensitive layer units having secondary differential values of 0.01-0.05 in more than 70% of the region of the principal gradation portion in the characteristic curves, and specific photographic sensitivity being 50 or more.

Further, in a color image forming method obtaining a color print from outputted digital images after the silver halide color photographic light sensitive material for image capture is exposed and development processed, followed by digital image conversion, wherein all of the color images formed from the red, green and blue sensitive layer units exhibit positive secondary differential values in more than 70% of the region of the principal gradation portion in the characteristic curves, and the digital image data is converted to signals in proportion to image luminance, after outputted signals in proportion to transmitted light volume are subjected to shading correction, pixel sensitivity correction and dark current correction, resulting in a color image forming method enabling formation of excellent color images, resulting in sufficiently high performance of the silver halide photographic material for image capture.

### DESCRIPTION OF THE PREFERRED EMBODIMENTS

The present invention will now be further detailed. The silver halide color photographic light sensitive material for image capture of this invention is characterized by exhibiting specific photographic sensitivity of 50 or more.

Specific photographic sensitivity of the silver halide color photographic material for image capture of this invention is determined based on the following test method according to ISO sensitivity. (JIS K 7614-1981)

(1) Test condition: Test were conducted in a room at 20±5° C., 60±10% RH, and photographic materials to be tested were stored under this conditions for more than 1 hr.

(2) Exposure: The relative spectral energy distribution of standard light at the exposure surface satisfies the following:

| | Relative | | Relative |
|---|---|---|---|
| Wavelength | spectral | Wavelength | spectral |
| (nm) | energy (1*) | (nm) | energy |
| 360 | 2 | 370 | 8 |
| 380 | 14 | 390 | 23 |
| 400 | 45 | 410 | 57 |
| 420 | 63 | 430 | 62 |
| 440 | 81 | 450 | 93 |
| 460 | 97 | 470 | 98 |
| 480 | 101 | 490 | 97 |
| 500 | 100 | 510 | 101 |
| 520 | 100 | 530 | 104 |
| 540 | 102 | 550 | 103 |
| 560 | 100 | 570 | 97 |
| 580 | 98 | 590 | 90 |
| 600 | 93 | 610 | 94 |
| 620 | 92 | 630 | 88 |
| 640 | 89 | 650 | 86 |
| 660 | 86 | 670 | 89 |
| 680 | 85 | 690 | 75 |
| 700 | 77 | | |

Note (1*):
Values are determined based on normalization of the value at 560 nm being 100.

Illumination variation at the exposure surface is conducted using an optical wedge, the spectral transparent density of which varies within 10% in the range of 360-less than 400 nm and within 5% in 400 and more-700 nm, with the exposure time being 1/100 sec.

(3) Development processing: The test samples were stored at 20±5° C., 60±10% RH during exposure and development processing.

Development processing is completed within 30-60 min. after exposure. Development processing is conducted using the C-41 Processing method developed by Eastman Kodak Company and described in The British Journal of Photography Annual 1988, pp. 196-198.

(4) Density measurement: Density is indicated by Log₁₀ (φO/φ), where φO is illumination flux, and φ is transmission flux at the measured portions. Geometrical conditions of density measurement are that illumination flux is a parallel flux to the normal line direction, the total flux being defused into a half space after transmitted as transmission flux and used as a standard, and correction using standard density pieces is conducted when other measurement methods are employed. Further, the emulsion surface faces a sensor device. In density measurement, each Status M density of blue, green and red is measured, and the spectral characteristics are adjusted to exhibit the values described in Tables 1 and 2 as a comprehensive characteristics of the light source, the optical system and the optical filters used for the densitometer, and the sensor device.

TABLE 1
Spectral characteristics of Status M density
(indicated as logarithms, normalized at the peak being 5.00)

| Wavelength | | | |
|---|---|---|---|
| nm | Blue | Green | Red |
| 400 | −0.40 | −6.29 | −55.1 |
| 410 | 2.10 | −5.23 | −52.5 |
| 420 | 4.11 | −4.17 | −49.9 |
| 430 | 4.63 | −3.11 | −47.3 |
| 440 | 4.37 | −2.05 | −44.7 |
| 450 | 5.00 | −0.99 | −42.1 |
| 460 | 4.95 | 0.07 | −39.5 |
| 470 | 4.74 | 1.13 | −36.9 |
| 480 | 4.34 | 2.19 | −34.3 |
| 490 | 3.74 | 3.14 | −31.7 |
| 500 | 2.99 | 3.79 | −29.1 |
| 510 | 1.35 | 4.25 | −26.5 |
| 520 | −0.85 | 4.61 | −23.9 |
| 530 | −3.05 | 4.85 | −21.3 |
| 540 | −5.25 | 4.98 | −18.7 |
| 550 | −7.45 | 4.98 | −16.1 |
| 560 | −9.65 | 4.80 | −13.5 |
| 570 | −11.9 | 4.44 | −10.9 |
| 580 | −14.1 | 3.90 | −8.29 |
| 590 | −16.3 | 3.15 | −5.69 |

TABLE 2

| Wavelength | | | |
|---|---|---|---|
| nm | Blue | Green | Red |
| 600 | −18.5 | 2.22 | −3.09 |
| 610 | −20.7 | 1.05 | −0.49 |
| 620 | −22.9 | −0.15 | 2.11 |
| 630 | −25.1 | −1.35 | 4.48 |
| 640 | −27.3 | −2.55 | 5.00 |
| 650 | −2.95 | −3.75 | 4.90 |
| 660 | −31.7 | −4.95 | 4.58 |
| 670 | −33.9 | −6.15 | 4.25 |
| 680 | −36.1 | −7.35 | 3.88 |
| 690 | −38.3 | −8.55 | 3.49 |
| 700 | −4.05 | −9.75 | 3.10 |
| 710 | −42.7 | −10.9 | 2.69 |
| 720 | −44.9 | −12.2 | 2.27 |
| 730 | −47.1 | −13.4 | 1.86 |
| 740 | −49.3 | −14.6 | 1.45 |
| 750 | −51.5 | −15.8 | 1.05 |

(5) Determination of specific photographic sensitivity: Using the results obtained after processing and density measurement under the conditions described in (1)-(4), specific photographic sensitivity was determined by the following procedure. To each minimum density of blue, green and red, exposure amount corresponding to a 0.15 higher density is indicated as lux·sec., and each of them is designated HB, HG and HR respectively. A larger value (indicating lower sensitivity) of HB and HR is designated HS.

Specific photographic sensitivity is calculated employing the following equation.

S=(2/HG×HS)^{1/2}

In this invention, specific photographic sensitivity determined using the above method is characterized by a value of 50 or more, preferably 100 or more and 3,200 or less, and more preferably between 1,000-1,600 inclusively.

In the silver halide color photographic light sensitive material for image capture of the present invention, it is characterized by all of the color images formed by the red, green and blue sensitive layer units, exhibiting secondary differential values of more than +0.05 in more than 70% of the region of the principal gradation portion in the characteristic curves.

The characteristic curves of this invention are referred to as density function curves, which are so-called D-Log H curves, plotted as a common logarithm of exposure amount H (as Log H) on the horizontal axis, and density D on the vertical axis. It is a D-Log E curve, for example, detailed in “The Theory of the Photographic Processing” 4^{th} ed., edited by T. H. James, on pp. 501-509, Macmillan Publishing Co., Inc., New York, 1977. Usually, 1.0 of ΔLog H and 1.0 of ΔD are configured at even intervals.

In this invention, the principal gradation portion is defined as the region from a density point of the minimum density value +0.1 to that of the maximum density value −0.3 on the characteristic curves by transmission density, after the silver halide color photographic material for image capture at sufficient exposure is processed employing the specified standard development processing.

This principal gradation portion is essentially the effective region to record captured images. In this invention, the object and effects are achieved in that the secondary differential values of the characteristic curves are +0.05 or more in 70% or more of the region of this principal gradation portion, and preferably 80-90%.

The secondary differential values of the characteristic curves of this invention are the values obtained by further primary differentiation of the primary differential values of the characteristic curves. These primary differential values of the characteristic curves are referred to also as point gamma (d D/d Log E), and is a characteristic value which indicates a density difference (d D) at a certain exposure range (d Log E), defined in the foregoing “The Theory of the Photographic Process”, edited by T. H. James, in pg. 502. The secondary differential value of this invention is obtained by further primary differentiation of the point gamma value, and is characteristics referring to the variation of the point gamma value.

In this invention, the characteristic curve exhibiting a secondary differential value of +0.05 or more shows the shape of the characteristic curve having characteristics of an increasing gradient of the characteristic curve y accompanying an increase of exposure amount. Specifically, in the characteristic curve of D-Log E coordinate, it shows a concave up curve toward the higher density, that is, an upward facing characteristic curve. It becomes evident that this curve is quite different from the conventional characteristic curve exhibiting nearly a straight line at the primary gradation portion, meaning that the curve is designed to maintain a primary function, in the relationship between the exposure amount Log E and the corresponding density D.

A secondary differential value of +0.05 or more in this invention means that the characteristic curve is a higher order function rather than a quadric. It is preferred to exhibit a value of 0.08 or more, and further preferred is 0.10 or more. Specifically preferred is exhibition of an exponential function.

In the silver halide color photographic light sensitive material for image capture of this invention, a method to achieve the characteristic curve exhibiting the secondary differential value defined in this invention is not specifically limited. For example, the curve may be approximated by obtaining a layer configuration of more than 2 layers having the same spectral sensitivity but different light sensitivity, and further the dominant layer of the lower sensitivity portion exhibits (1) enhanced higher maximum density, or (2) increased gradation, compared to conventional straight line type characteristic curve. For example, (1) can be achieved by an increase of added amounts of silver halide emulsion and couplers, (2) can be achieved by enhancement of the monodispersion degree of the silver halide emulsion. Further, the curve may be approximated by use of a plurality of silver halide emulsions having different sensitivity in the dominant layer of the lower sensitivity portion, (3) can be achieved by an increase in an addition ratio of the silver halide emulsion in the lower sensitivity layer, or (4) can be achieved by use of a high contrast silver halide emulsion in the lower sensitivity layer.

In other words, of the plurality of silver halide emulsions used in a single spectral sensitivity layer, the characteristic curve, being approximation of a high order function or an exponential function of this invention, can be obtained by use of a high contrast emulsion and an increase of its ratio in the lower sensitivity layer.

In the silver halide color sensitive material for image capture in this invention, one of the characteristics is that the minimum transmission density of each light sensitive layer is 0.15 or less, which can be achieved by a decrease of colored couplers for masking which is employed in conventional silver halide color sensitive material for image capture, or by a decrease of fogging caused by the silver halide emulsion. In cases when the amount of colored couplers are reduced, the masking effects are reduced, but can easily be complemented by image processing computation during digital image data conversion, enabling compensation of the effects of the finally obtained images. Further, reduction of fogging of a silver halide emulsion can be achieved by use of well-known techniques, and basically without limitation. Further, as mentioned later, in cases when a development inhibitor releasing compound is reduced from currently employed levels, reduction of fogging can be easily achieved because sensitivity load imposed on the silver halide emulsion is also decreased.

In the silver halide color sensitive material for image capture of this invention, the added amount of colored couplers is decreased or completely eliminated, but in cases when even a small amount of these is used, any couplers within the public domain may be employed. Examples of specifically usable colored magenta couplers and colored cyan couplers include colored magenta couplers represented by Formulas (I) and (II), and colored cyan couplers represented by Formulas (III), (IV) and (V), described in JP-A 10-3144.

In the silver halide color photographic sensitive material for image capture of this invention, the relationships among the color separation exposure gradation of γR, γG and γB and the white exposure gradation of γWR, γWG and γWB being within the foregoing Equations (1)-(3) means that namely, the so-called inter-image effect in the current silver halide color photographic material is in the state of being small or can hardly recognized.

In addition, the color separation exposure gradation is the gradation resulting from development processing after separate exposures with only light rays sensitizing each light sensitive layer unit. The color separation exposure is usually conducted using a standard white light source with a wedge type filter and a red, green or red filter. In cases when Wratten filters, produced by Eastman Kodak Company, are employed, a No. 26 filter for red light exposure, a No. 99 filter for green light exposure and a No. 98 filter for blue light exposure are commonly used.

Further, the white exposure gradation means gradation resulting from development processing after exposure using the foregoing standard white light source with the wedge type filters.

The gradations used for evaluation of the color separation exposure gradations and the white exposure gradation are each point gamma values at the center point of maximum transmission density and minimum transmission density of the characteristic curves. In conventional silver halide photographic sensitive material for image capture, the ratio of the color separation exposure gradation to the white exposure gradation is quite large, generally being within a range of 1.2-1.5.

To achieve such relationships between color separation exposure gradation and the white exposure gradation of this invention, it is effective to employ a method to reduce or eliminate development inhibitor releasing compounds which are widely used in conventional silver halide color photographic sensitive material for image capture, or to control halogen compositions of the silver halide emulsion. By employing these configurations, a condition with a little or no inter-image effect is realized.

To achieve a ratio of the color separation exposure gradation to the white exposure gradation within the preferable range, it is effective to set the added amount of the development inhibitor releasing compounds to be 0.5 mol or less per mol of the silver halide, specifically preferably 0.1 mol or less, and more preferably 0-0.05 mol.

Further, in silver halide emulsions, it is effective to reduce the silver iodide content with conventional silver iodobromide. Generally, the average silver iodide content in silver halide emulsions used for the conventional silver halide color photographic sensitive material for image capture is 8 mol % or more, however, the conditions defined in this invention may be effectively achieved by effecting a content of 1-7 mol %, and preferably 2-6 mol %.

In this invention, exposure latitude (Δ Log H) of the major gradation portion in the characteristic curve is preferably 2.5 or more, and specifically preferably 2.8 or more.

Further, in this invention, the maximum density is preferably 2.0 or more and 3.5 or less, and specifically preferably 2.5 or more and 3.5 or less. In cases when it is greater than 3.5, the effects of this invention are plateaued, and thus, the raw materials such as silver halide and couplers are not as effectively utilized. Further, when less than 2.0, the effects of this invention are insufficiently exhibited.

In this invention, one of the characteristics is that in the region of more than 70% of the major gradation portion in the characteristic curve, the exponential function matching standard deviation σ is 0.01-0.05.

The exponential function matching standard deviation σ of this invention means the parameter exhibiting the matching degree of the characteristic curve with the exponential function curve, and is defined as follow.

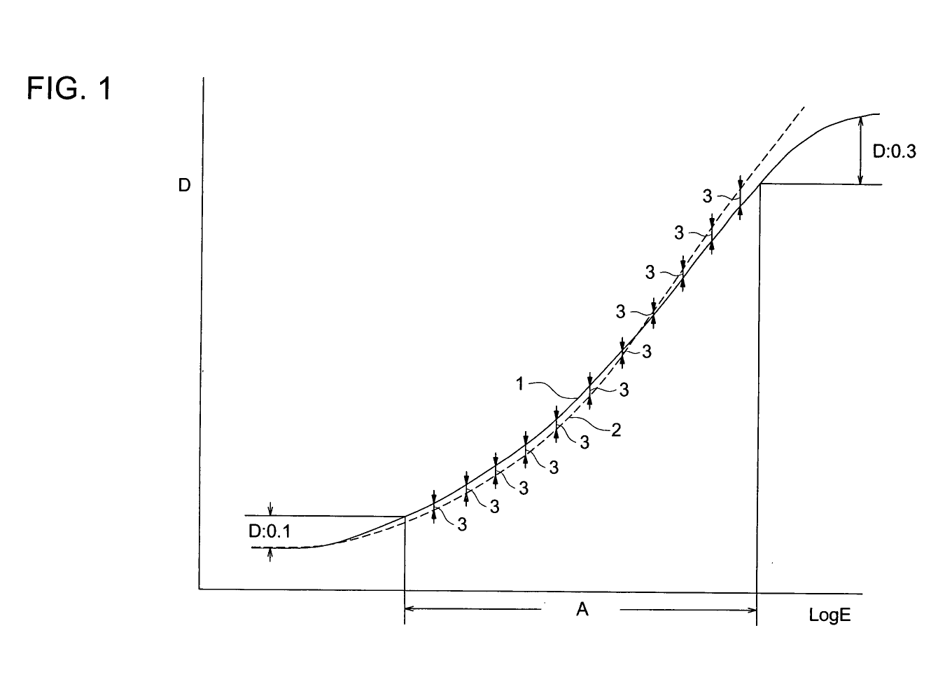

In FIG. 1, a conceptual diagram showing details of the exponential function matching standard deviation of the present invention is exhibited.

Also in FIG. 1, regarding the characteristic curve 1 and the exponential function curve 2 represented by Equation (4), the exponential function curve 2, being an approximation of the major gradation region A of the characteristic curve is set up by selecting a and b as appropriate. Then, density difference ΔD (the density difference between the density point on the characteristic curve and the density point on the exponential function curve) in the direction of the density D axis between characteristic curve 1 and exponential function curve 2, is measured at 10 optional points in even intervals in the direction of the exposure amount Log E axis of the major gradation portion. Thereafter, the standard deviation value obtained under the conditions in which the average of ΔD (3) is closest to zero and the standard deviation of ΔD is minimized, is defined as exponential function matching standard deviation σ.

D=be^{a} Equation (4)

wherein D is transmission density, e is an exponential value, and a and b are each constant numbers.

The development processing of the silver halide color photographic sensitive material for image capture in this invention is conducted using the processing methods and the processing solutions for color negative films described in Annual of the British Journal of Photography (1988), pp. 196-198.

The transmission densities measured in this invention are each the values obtained by measurement with red light, green light and blue light using a transmission densitometer model 310T, manufactured by X-Rite Inc.

To read the image information obtained after development processing, a scanner is usually employed. A scanner in this invention means a device for optically scanning a photographic sensitive material after development processing, and then, converting the transmitted optical density to image data. During scanning, optical parts of a scanner are usually transferred in a direction different from that of the photographic sensitive material, so as to scan at least the necessary region of the photographic sensitive material, and is the recommended method. However, it may be possible that only optical parts of a scanner are transferred while the photographic sensitive material is fixed, or optical parts of a scanner are fixed and the photographic sensitive material is conveyed. Further, combinations of these means are acceptable.

A light source to read image information may be employed basically without limitation, such as a tungsten lamp, a fluorescent lamp, a light-emitted diode or laser light. A tungsten lamp is preferable from the viewpoint of cost, and laser light (being a coherent light source) is preferable from the viewpoint of stability, intensity and reduced beam scattering. Reading methods are also not specifically limited, but it is preferable to enable reading with transmitted light from the viewpoint of sharpness.

In this invention, images obtained on photographic sensitive material are read using a scanner and converted to digital information, and thus, can be digitally recorded on other recording medium.

In the color image forming method of this invention, the digital image data conversion of the silver halide color photographic sensitive material is characterized by conversion to signals in proportion to image luminance with nonlinear conversion, after the outputted signals, and in proportion to the transmitted light volume, are subjected to shading correction, pixel sensitivity correction and dark current correction.

Shading correction and pixel sensitivity correction of this invention mean correction of fluctuation in sensitivity of bits of a photo acceptance unit and the correction of fluctuation due to distortion such as illumination light distribution and reduction of marginal light amount of the lens. Further, dark current correction means to correct the current flowing through a photo acceptance unit even when light is not radiated.

The color image forming method of this invention is found to be extremely effective to enhance quality of the obtained images by the correction of digital image data conversion as defined in this invention, and the following conversion to signals in proportion to image luminance with nonlinear conversion. Contrarily, with the digital image data conversion method as a prior procedure of conducting the nonlinear conversion process in advance, followed by shading correction, pixel sensitivity correction and dark current correction, to convert to signals in proportion to image luminance, the desired objective effects of this invention cannot be achieved.

As printers usable in this invention, listed are color positive image forming type printers such as an ink-jet, dye sublimation type thermal transfer, wax type thermal transfer, color electrography, and instant photographic printers.

Next, the silver halide color photographic light sensitive material for image capture of the present invention will be described.

The silver halide emulsions usable in the silver halide color photographic material for image capture of this invention are described in selected sections of Research Disclosure (hereinafter, shown as RD), No. 308,119.

The described locations are listed below. Each of the numeric values indicates a page or a section.

[Item]
[RD 308, 119]

| | page | Section |
|---|---|---|
| Iodine content | 993 | I-A |
| Production methods | 993 | I-A |
| | 994 | I-E |
| Crystal habit | | |
| Normal crystal | 993 | I-A |
| Twin crystal | 993 | I-A |
| Epitaxial | 993 | I-A |
| Halogen composition | | |
| Uniform | 993 | I-B |
| Nonuniform | 993 | I-B |
| Halogen conversion | 994 | I-C |
| Halogen substitution | 994 | I-C |
| Metal containing | 994 | I-D |
| Monodispersion | 995 | I-F |
| Solvent addition | 995 | I-F |
| Latent image | | |
| forming position | | |
| Surface | 995 | I-G |
| Interior | 995 | I-G |
| Applied photographic | | |
| sensitive material | | |
| Negative | 995 | I-H |
| Positive (containing | 995 | I-H |
| internal fogged particles) | | |
| Emulsion mixing | 995 | I-J |
| Desalting | 995 | II-A |

In this invention, silver halide emulsions conducted for physical ripening, chemical ripening and spectral sensitization are employed. The additives used in these processes are described in RD Nos. 17,643, 18,716 and 308,119. The described positions are listed below.

| | [Items] | | | |
|---|---|---|---|---|
| | [RD No. 308,119] | | [RD No. 17,643] | [RD No. 18,716] |
| | Page | Section | Page | Page |
| Chemical | 996 | III-A | 23 | 648 |
| sensitizing | | | | |
| agents | | | | |
| Spectral | 996 | IV-A-A, | 23-24 | 648-649 |
| sensitizing | | A-B, A-C, | | |
| agents | | A-D, A-H, | | |
| | | A-I, A-J, | | |
| Super | 996 | IV-A-E, A-J | 23-24 | 648-649 |
| spectral | | | | |
| sensitizing | | | | |
| agents | | | | |
| Fogging | 998 | VI | 24-25 | 649 |
| inhibiting | | | | |
| agents | | | | |
| Stabilizing | 998 | VI | 24-25 | 649 |
| agents | | | | |

Additives for photography well known in the art usable for the silver halide color photographic light sensitive material of this invention are also described in the foregoing RD. The relevant described locations are listed below.

| | [Items] | | | |
|---|---|---|---|---|
| | [RD No. 308,119] | | [RD No. 17,643] | [RD No. 18,716] |
| | Page | Section | Page | Page |
| Anti-color | 1,002 | VII-I | 25 | 650 |
| contamination | | | | |
| agents | | | | |
| Dye image | 1,001 | VII-J | 25 | |
| stabilizing | | | | |
| agents | | | | |
| Whitening | 998 | V | 24 | |
| agents | | | | |
| UV | 1,003 | VIII-I | 25-26 | |
| absorbing | | VIII-C | | |
| agents | | | | |
| Light | 1,003 | VIII | 25-26 | |
| absorbing | | | | |
| agents | | | | |
| Light | 1,003 | VIII | | |
| scattering | | | | |
| agents | | | | |
| Filter dyes | 1,003 | VIII | 25-26 | |
| Binders | 1,003 | IX | 26 | 651 |
| Antistatic | 1,006 | XIII | 27 | 650 |
| agents | | | | |
| Hardening | 1,004 | X | 26 | 651 |
| agents | | | | |
| Plastisizing | 1,006 | XII | 27 | 650 |
| materials | | | | |
| Lubricating | 1,006 | XII | 27 | 650 |
| agents | | | | |
| Surface active | 1,005 | XI | 26-27 | 650 |
| agents · coating | | | | |
| aids | | | | |
| Matting agents | 1,007 | XVI | | |
| Developing | 1,001 | XX-B | | |
| agent | | | | |
| (contained in | | | | |
| the silver | | | | |
| halide color | | | | |
| photographic | | | | |
| sensitive | | | | |
| material) | | | | |

In the photographic sensitive layers of this invention, various couplers may be employed, and specific examples are described in the foregoing RD. The relevant described locations are listed below.

| | [Items] | | |
|---|---|---|---|
| | [RD No. 308,119] | | [RD No. 17,643] |
| | Page | Section | Section |
| Yellow couplers | 1,001 | VII-D | VII C-G |
| Magenta couplers | 1,001 | VII-D | VII C-G |
| Cyan couplers | 1,001 | VII-D | VII C-G |
| Colored couplers | 1,002 | VII-G | VII G |
| DIR couplers | 1,001 | VII-F | VII F |
| BAR couplers | 1,002 | VII-F | |
| Other usable residual group | 1,001 | VII-F | |
| releasing couplers | | | |
| Alkali soluble couplers | 1,001 | VII-E | |

The foregoing additives may be added using a dispersion method described in RD No. 308,119, Sec. XIV.

To the silver halide color photographic sensitive material of this invention, provided may be auxiliary layers such as filter layers and intermediate layers, described in the foregoing RD No. 308,119, Sec. VII-K.

The silver halide color photographic sensitive material of this invention may take various layer configurations such as conventional layer order, inverse layer order and unit structures, described in the foregoing RD No. 308,119, Sec. VII-K.

To conduct development processing of the silver halide color photographic sensitive material of this invention, allowable are developing agents in the public domain described in, for example, “The Theory of the Photographic Process” 4^{th} edition, edited by T. H. James, on pp. 291-334, and “Journal of the American Chemical Society”, vol. 73, No. 3, pg. 100 (1951). Development processing is conducted with common methods described in the foregoing RD No. 17,643, on pp. 28-29, RD No. 18,716, on pg. 615 and RD No. 308,119, in Sec. XIX.

### EXAMPLES

The present invention will now be described below with samples, but the embodiments of this invention are not limited to these examples.

### Example 1

### Preparation of Silver Halide Color Photographic Light Sensitive Material

### Preparation of Sample 101

Onto a 125 μm thick cellulose triacetate film substrate provided with a subbing layer, the following coating compositions were applied to obtain Sample 101 (being a comparative sample) as a multi-layered silver halide color photographic sensitive material for image capture.

In all descriptions below, the applied amount of each additive agent to the silver halide color photographic material is indicated by grams per m² unless otherwise specified. Further, the amount of a silver halide and colloidal silver is indicated in terms of metallic silver, and the amount of spectral sensitizing dye is indicated by mol per mol of silver halide.

The 1^{st} Layer: Antihalation Layer

| | |
|---|---|
| Black colloidal silver | 0.18 |
| UV absorbing agent (UV-1) | 0.3 |
| Colored coupler CM-1) | 0.08 |
| Colored coupler (CC-1) | 0.05 |
| High boiling point | 0.16 |
| organic solvent (OIL-1) | |
| High boiling point | 0.5 |
| organic solvent (OIL-2) | |
| Gelatin | 1.5 |

The 2^{nd} Layer: Intermediate layer

| | |
|---|---|
| Colored coupler (CC-1) | 0.035 |
| High boiling point organic | 0.08 |
| solvent (OIL-2) | |
| Gelatin | 0.7 |

The 3^{rd} Layer: Low Sensitivity Red Sensitive Layer

| | |
|---|---|
| Silver iodobromide emulsion a | 0.30 |
| Silver iodobromide emulsion b | 0.06 |
| Spectral sensitizing dye (SD-1) | 1.10 × 10⁻⁵ |
| Spectral sensitizing dye (SD-2) | 5.40 × 10⁻⁵ |
| Spectral sensitizing dye (SD-3) | 1.25 × 10⁻⁴ |
| Cyan coupler (C-1) | 0.30 |
| Colored coupler (CC-1) | 0.054 |
| DIR compound (DI-1) | 0.02 |
| High boiling point organic | 0.3 |
| solvent (OIL-2) | |
| Compound (AS-2) | 0.001 |
| Gelatin | 1.5 |

The 4^{th} Layer: Intermediate Sensitivity Red Sensitive Layer

| | |
|---|---|
| Silver iodobromide emulsion b | 0.37 |
| SD-1 | 1.50 × 10⁻⁵ |
| SD-2 | 7.00 × 10⁻⁵ |
| SD-3 | 1.65 × 10⁻⁴ |
| C-1 | 0.23 |
| CC-1 | 0.038 |
| DI-1 | 0.01 |
| OIL-2 | 0.27 |
| AS-2 | 0.001 |
| Gelatin | 1.5 |

The 5^{th} Layer: High Sensitivity Red Sensitive Layer

| | |
|---|---|
| Silver iodobromide emulsion a | 0.04 |
| Silver iodobromide emulsion b | 0.18 |
| Silver iodobromide emulsion c | 0.50 |
| SD-1 | 1.30 × 10⁻⁵ |
| SD-2 | 6.00 × 10⁻⁵ |
| SD-3 | 1.40 × 10⁻⁴ |
| C-1 | 0.12 |
| C-2 | 0.03 |
| CC-1 | 0.03 |
| DI-1 | 0.004 |
| OIL-2 | 0.19 |
| AS-2 | 0.002 |
| Gelatin | 1.2 |

The 6^{th} Layer: Intermediate layer

| | |
|---|---|
| OIL-1 | 0.08 |
| AS-1 | 0.08 |
| Gelatin | 0.9 |

The 7^{th} Layer: Low Sensitivity Green Sensitive Layer

| | |
|---|---|
| Silver iodobromide emulsion a | 0.22 |
| Silver iodobromide emulsion d | 0.09 |
| SD-4 | 1.50 × 10⁻⁴ |
| SD-5 | 3.75 × 10⁻⁵ |
| M-1 | 0.35 |
| CM-1 | 0.12 |
| OIL-1 | 0.49 |
| DI-2 | 0.017 |
| AS-2 | 0.0015 |
| Gelatin | 2.2 |

The 8^{th} Layer: Intermediate Sensitivity Green Sensitive Layer

| | |
|---|---|
| Silver iodobromide emulsion d | 0.46 |
| SD-5 | 2.10 × 10⁻⁵ |
| SD-6 | 1.61 × 10⁻⁴ |
| SD-7 | 2.40 × 10⁻⁵ |
| M-1 | 0.1 |
| CM-1 | 0.05 |
| OIL-1 | 0.15 |
| AS-2 | 0.001 |
| Gelatin | 1.6 |

The 9^{th} Layer: High Sensitivity Green Sensitive Layer

| | |
|---|---|
| Silver iodobromide emulsion a | 0.03 |
| Silver iodobromide emulsion e | 0.47 |
| SD-5 | 1.90 × 10⁻⁵ |
| SD-6 | 1.43 × 10⁻⁴ |
| SD-7 | 2.10 × 10⁻⁵ |
| M-1 | 0.033 |
| M-2 | 0.023 |
| CM-1 | 0.023 |
| DI-1 | 0.009 |
| DI-2 | 0.0009 |
| OIL-1 | 0.08 |
| AS-2 | 0.002 |
| Gelatin | 1.2 |

The 10^{th} Layer: Yellow Filter Layer

| | |
|---|---|
| Yellow Colloidal Silver | 0.08 |
| OIL-1 | 0.06 |
| AS-1 | 0.8 |
| Gelatin | 0.9 |

The 11^{th} Layer: Low Sensitivity Blue Sensitive Layer

| | |
|---|---|
| Silver iodobromide emulsion a | 0.18 |
| Silver iodobromide emulsion f | 0.14 |
| Silver iodobromide emulsion g | 0.08 |
| SD-8 | 1.15 × 10⁻⁴ |
| SD-9 | 5.60 × 10⁻⁵ |
| SD-10 | 2.56 × 10⁻⁵ |
| Y-1 | 1.0 |
| OIL-1 | 0.40 |
| AS-2 | 0.002 |
| FS-1 | 0.08 |
| Gelatin | 3.0 |

The 12^{th} Layer: High Sensitivity Yellow Sensitive Layer

| | |
|---|---|
| Silver iodobromide emulsion g | 0.30 |
| Silver iodobromide emulsion h | 0.30 |
| SD-8 | 7.12 × 10⁻⁵ |
| SD-10 | 2.39 × 10⁻⁵ |
| Y-1 | 0.1 |
| OIL-1 | 0.04 |
| AS-2 | 0.002 |
| FS-1 | 0.01 |
| Gelatin | 1.10 |

The 13^{th} Layer: 1^{st} Protective Layer

| | |
|---|---|
| Silver iodobromide emulsion I | 0.3 |
| UV-1 | 0.11 |
| UV-2 | 0.53 |
| Gelatin | 0.9 |

The 14^{th} Layer: 2^{nd} Protective Layer

| | |
|---|---|
| PM-1 | 0.15 |
| PM-2 | 0.04 |
| WAX-1 | 0.02 |
| Gelatin | 0.55 |

Other than the components described above, appropriately applied to each layer were compounds SU-1 and SU-2, viscosity adjusting agent V-1, hardening agents H-1 and H-2, stabilizing agents ST-1 and ST-2, antifogging agents AF-1, AF-2 and AF-3, dyes AI-1, AI-2 and AI-3, and antiseptic agent D-1.

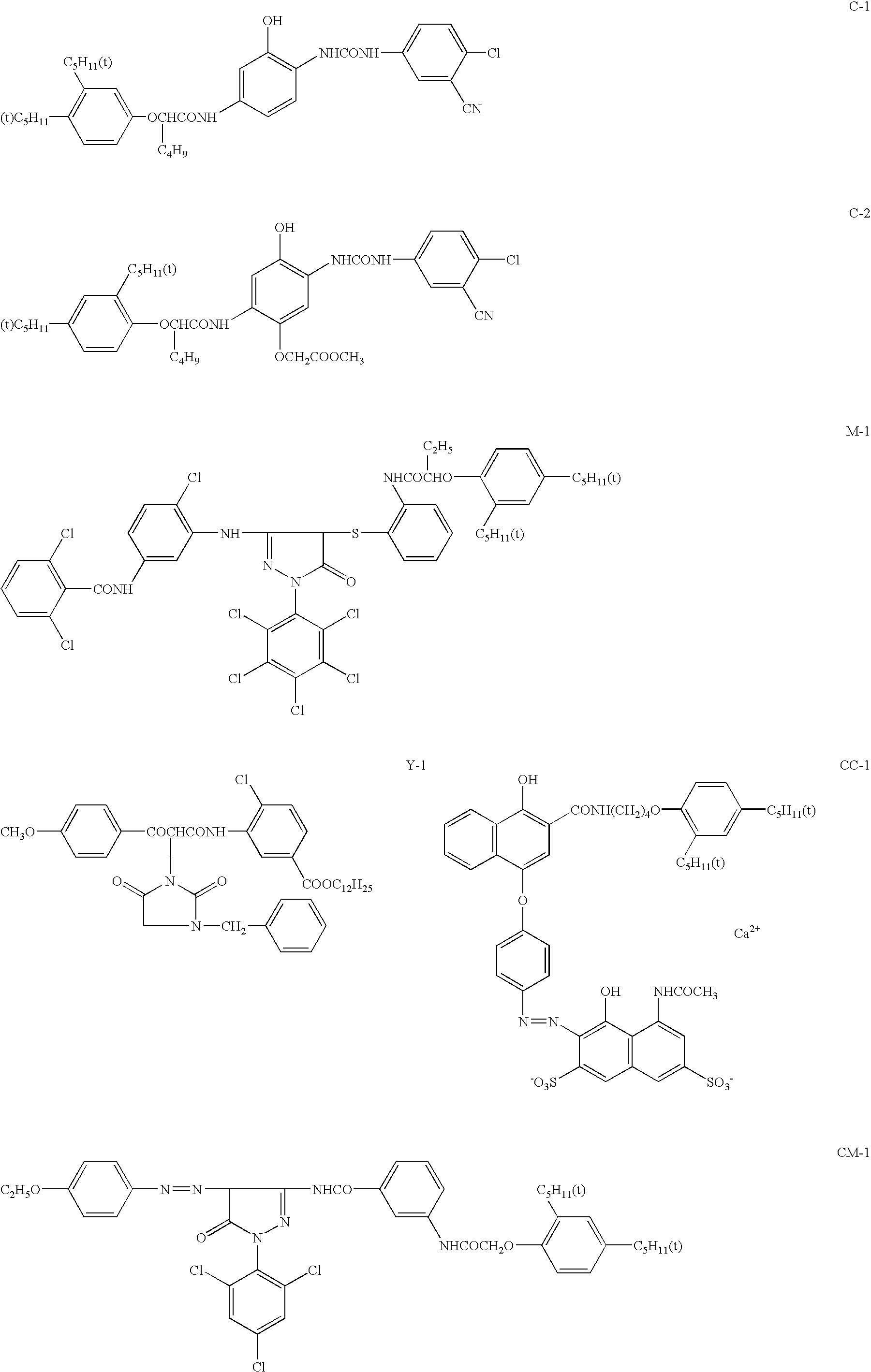

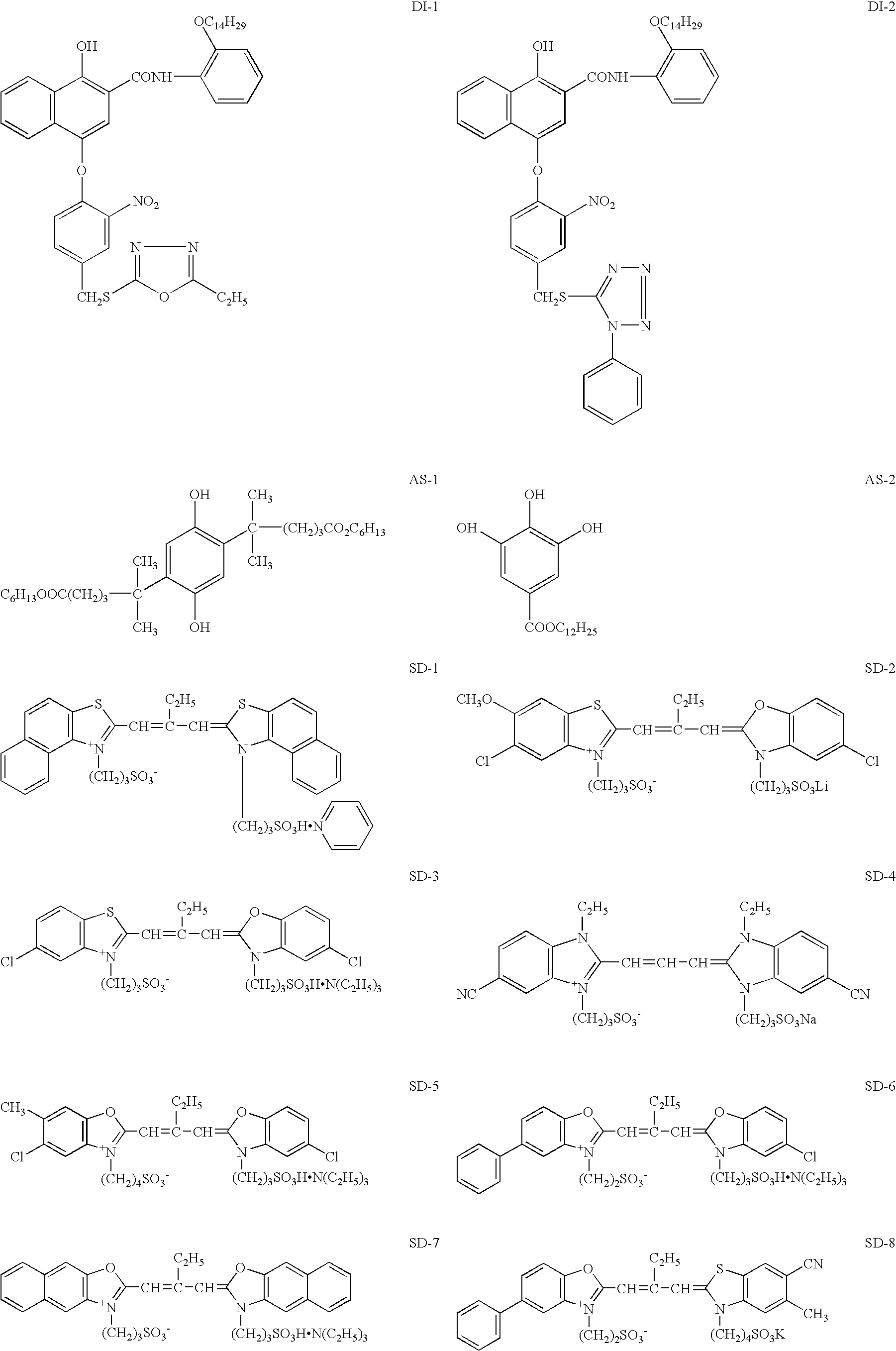

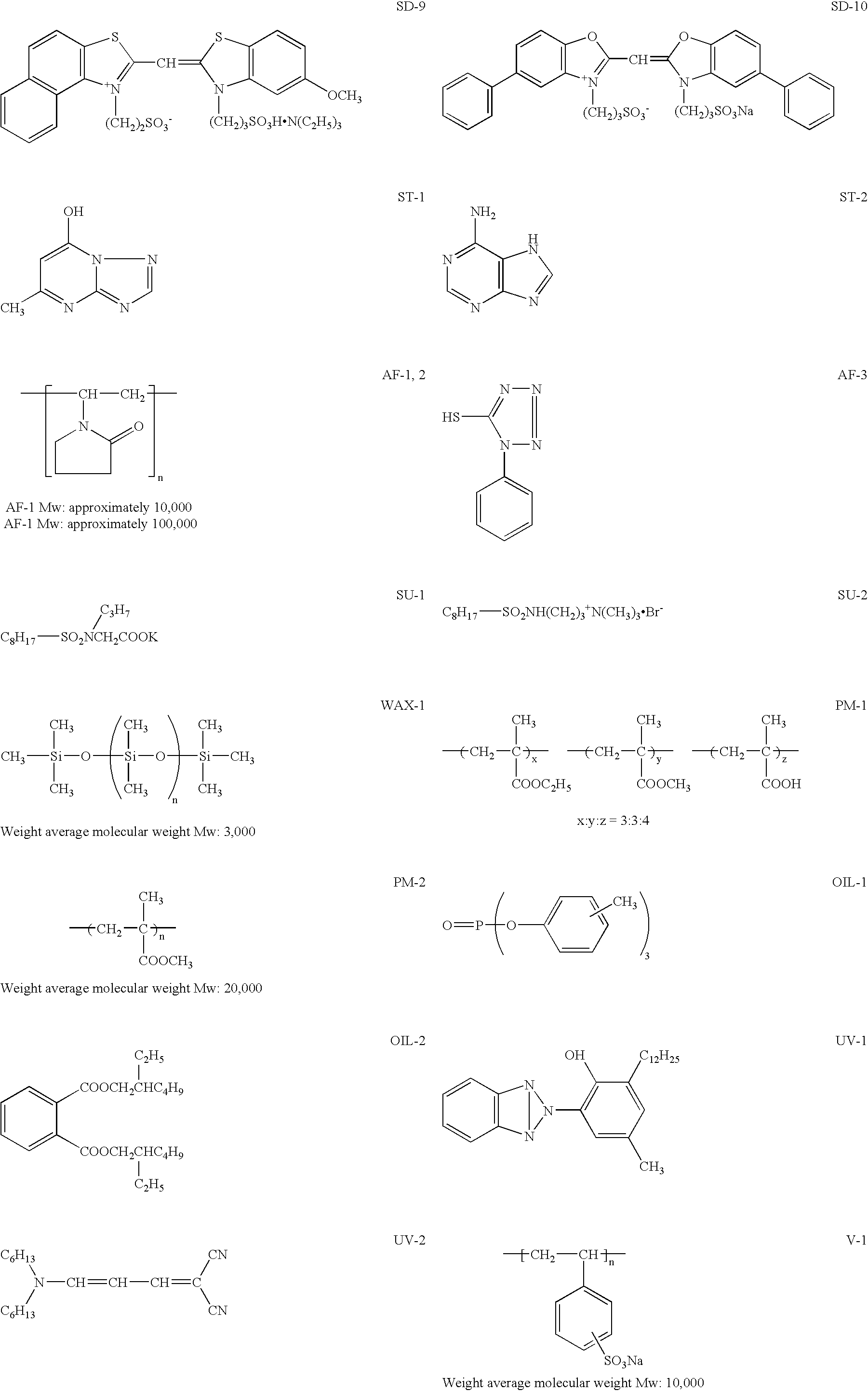

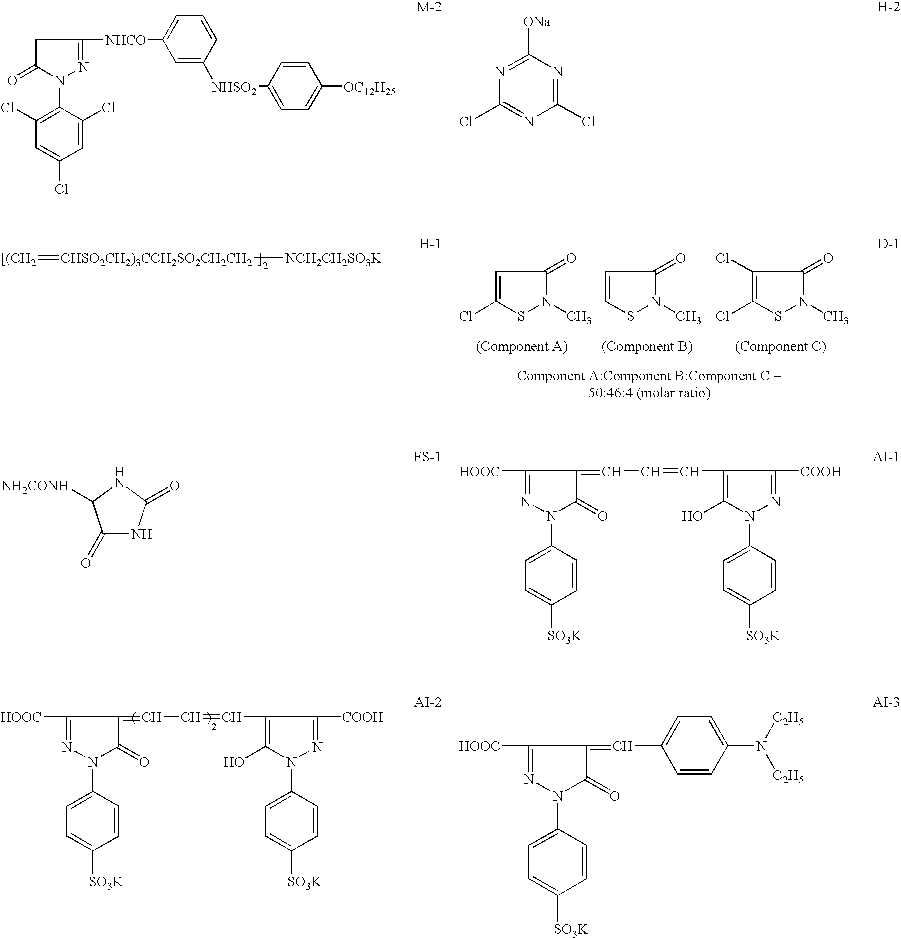

The list of emulsions employed in foregoing Sample 101 are shown in following Table 3. The average particle diameters are shown in term of cubic.

TABLE 3

| | Average | Average | | |
|---|---|---|---|---|
| | AgI | particle | | Diameter/ |
| | content | diameter | Crystal | Thickness |
| Emulsion | (mol %) | (μm) | habit | Ratio |
| Silver | 2.0 | 0.27 | Regular | 1.0 |
| iodobromide | | | crystal | |
| emulsion a | | | | |
| Silver | 3.6 | 0.48 | Twin | 3.7 |
| iodobromide | | | | |
| emulsion b | | | | |
| Silver | 7.6 | 0.68 | Twin | 6.5 |
| iodobromide | | | | |
| emulsion c | | | | |
| Silver | 4.7 | 0.45 | Twin | 3.7 |
| iodobromide | | | | |
| emulsion d | | | | |
| Silver | 5.6 | 0.70 | Twin | 7.0 |
| iodobromide | | | | |
| emulsion e | | | | |
| Silver | 8.0 | 0.38 | Regular | 1.0 |
| iodobromide | | | crystal | |
| emulsion f | | | | |
| Silver | 8.0 | 0.65 | Twin | 1.5 |
| iodobromide | | | | |
| emulsion g | | | | |
| Silver | 8.0 | 0.80 | Twin | 2.0 |
| iodobromide | | | | |
| emulsion h | | | | |
| Silver | 2.0 | 0.03 | Regular | 1.0 |
| iodobromide | | | crystal | |
| emulsion i | | | | |

Silver iodobromide emulsions b, e, g and h contained iridium in the amount of 1×10⁻⁷-1×10⁻⁶ mol/1 mol Ag.

Each of the emulsions other than foregoing silver iodobromide emulsion i was subjected to chemical sensitization so that the relationship of fogging vs sensitivity was optimized, by applying sodium thiosulfate, chloroauric acid, and potassium thiocyanate, after addition of the foregoing spectral sensitizing dyes.

### Preparation of Samples 102-108

Samples 102-108 were prepared in the same manner as Sample 101, except that following gradation correction actions 1-3 were provided in the combinations described below.

### Gradation Correction Action 1

In the layer configuration of Sample 101 above, gradation correction action 1 was an action in which all of colored couplers CC-1 and CM-1 employed in the 1^{st}-5^{th} layer and the 7^{th}-9^{th} layer were eliminated.

### Gradation Correction Action 2

In the layer configuration of Sample 101 above, gradation correction action 2 was one in which all of development inhibitor releasing compounds DI-1 and DI-2 employed in the 3^{rd}-5^{th}, 7^{th} and 9^{th} layer were eliminated.

### Gradation Correction Action 3

In the layer configuration of Sample 101 above, gradation correction action 3 was one in which each amount of the silver iodobromide emulsion and each applied amount of couplers in each spectral sensitive layer were changed as described in Table 4.

TABLE 4

| | |
|---|---|
| Silver | |
| iodobromide | |
| emulsion | Coupler |

| | | Applied | | Applied |
|---|---|---|---|---|
| | | amount | | amount |
| Layer name | Kind | (Ag g/m²) | Kind | (g/m²) |
| The 3^{rd} layer | a | 0.42 | C-1 | 0.41 |
| | b | 0.07 | | |
| The 4^{th} layer | b | 0.30 | C-1 | 0.20 |
| The 5^{th} layer | a | 0.04 | C-1 | 0.11 |
| | b | 0.16 | C-2 | 0.03 |
| | c | 0.50 | | |
| The 7^{th} layer | a | 0.31 | M-1 | 0.47 |
| | d | 0.11 | | |
| The 8^{th} layer | d | 0.37 | M-1 | 0.09 |
| The 9^{th} layer | a | 0.02 | M-1 | 0.033 |
| | e | 0.47 | M-2 | 0.023 |
| The 11^{th} layer | a | 0.25 | Y-1 | 1.28 |
| | f | 0.17 | | |
| | g | 0.08 | | |
| The 12^{th} Layer | g | 0.27 | Y-1 | 0.10 |
| | h | 0.30 | | |

### Gradation Correction Actions for Samples 102-108

Sample 102 (comparative sample): Gradation correction action 1

Sample 103 (this invention): Gradation correction action 1+Gradation correction action 3

Sample 104 (comparative sample): Gradation correction action 2

Sample 105 (comparative sample): Gradation correction action 3

Sample 106 (comparative sample) Gradation correction action 1+Gradation correction action 2

Sample 107 (this invention): Gradation correction action 2+Gradation correction action 3

Sample 107 (this invention): Gradation correction action 1+Gradation correction action 2+Gradation correction action 3

### Measurement of Characteristic Values of each Sample Exposure and Development

### White Light Exposure

Each Sample prepared as above was subjected to wedge exposure at 1/200 sec. using a light source at a color temperature of 5,400 K, after which the standard development processing described below was conducted to prepare each color-developed sample.

### Processing Conditions

| | Processing | Processing | Replenishment |
|---|---|---|---|
| Process | time | temperature | rate* |
| Color Development | 3 min. 15 sec. | 38 ± 0.3° C. | 780 ml |
| Bleaching | 45 sec. | 38 ± 2.0° C. | 150 ml |
| Fixing | 1 min. 30 sec. | 38 ± 2.0° C. | 830 ml |
| Stabilizing | 1 min. | 38 ± 5.0° C. | 830 ml |
| Drying | 1 min. | 55 ± 5.0° C. | |

*Replenishment rates were volume per m² of the samples.

### Components of Each Processing Solution

The color development solution, bleaching solution, fixing solution, stabilizing solution and the replenishment solution of these are shown below.

### Color Development Solution

| | |
|---|---|
| Water | 800 ml |
| Potassium carbonate | 30 g |
| Sodium hydrogen carbonate | 2.5 g |
| Potassium sulfite | 3.0 g |
| Sodium bromide | 1.3 g |
| Potassium iodide | 1.2 mg |
| Hydroxylamine sulfate | 2.5 g |
| Sodium chloride | 0.6 g |
| 4-amino-3-methyl-N-ethyl-N- | 4.5 g |
| (β-hydroxyethyl)aniline sulfate | |
| Diethylenetriaminetetraacetic acid | 3.0 g |
| Potassium hydroxide | 1.2 g |

The total volume was brought to 1 L by addition of water, after which the pH was adjusted to 10.06 using potassium hydroxide or 20% sulfuric acid.

### Color Development Replenishment Solution

| | |
|---|---|
| Water | 800 ml |
| Potassium carbonate | 35 g |
| Sodium hydrogen carbonate | 3 g |
| Potassium sulfite | 5 g |
| Sodium bromide | 0.4 g |
| Hydroxylamine sulfate | 3.1 g |
| 4-amino-3-methyl-N-ethyl-N- | 6.3 g |
| (β-hydroxyethyl)aniline sulfate | |
| Potassium hydroxide | 2 g |
| Diethylenetriaminetetraacetic acid | 3.0 g |

The total volume was brought to 1 L by addition of water, after which the pH was adjusted to 10.18 using potassium hydroxide or 20% sulfuric acid.

### Bleaching Solution

| | |
|---|---|
| Water | 700 ml |
| 1,3-diaminopropanetetraacetic acid | 125 g |
| iron (III) ammonium | |
| Ethylenediaminetetraacetic acid | 2 g |
| Sodium nitrate | 40 g |
| Ammonium bromide | 150 g |
| Glacial acetic acid | 40 g |

The total volume was brought to 1 L by addition of water, after which the pH was adjusted to 4.4 using aqueous ammonia or glacial acetic acid.

### Bleaching Replenishment Solution

| | |
|---|---|
| Water | 700 ml |
| 1,3-diaminopropanetetraacetic acid | 175 g |
| iron (III) | |
| Ethylenediaminetetraacetic acid | 2 g |
| Sodium nitrate | 50 g |
| Ammonium bromide | 200 g |
| Glacial acetic acid | 56 g |

The pH was adjusted to 4.4 using aqueous ammonia or glacial acetic acid, after which the total volume was brought to 1 L by addition of water.

### Fixing Solution

| | |
|---|---|
| Water | 800 ml |
| Ammonium thiocyanate | 120 g |
| Ammonium thiosulfate | 150 g |
| Sodium sulfite | 15 g |
| Ethylenediaminetetraacetic acid | 2 g |

The pH was adjusted to 6.2 using aqueous ammonia or glacial acetic acid, after which the total volume was brought to 1 L by addition of water.

### Fixing Replenishment Solution

| | |
|---|---|
| Water | 800 ml |
| Ammonium thiocyanate | 150 g |
| Ammonium thiosulfate | 180 g |
| Sodium sulfite | 20 g |
| Ethylenediaminetetraacetic acid | 2 g |

The pH was adjusted to 6.5 using aqueous ammonia or glacial acetic acid, after which the total volume was brought to 1 L by addition of water.

### Stabilizing Solution and Stabilizing Replenishment Solution

| | |
|---|---|
| Water | 900 ml |
| Para-octylphenyl polyoxyethylene | 2.0 g |
| ether (n = 10) | |
| dimethylol urea | 0.5 g |
| Hexamethylenetetramine | 0.2 g |
| 1,2-benzoisothiazoline-3-one | 0.1 g |
| siloxane (L-77, produced by UCC.) | 0.1 g |
| Aqueous ammonia | 0.5 ml |

The total volume was brought to 1 L by addition of water, after which the pH was adjusted to the value of 8.5 using aqueous ammonia or a 50% aqueous solution of sulfuric acid.

### Color Separation Exposure

Each of the samples was wedge-exposed at 1/200 sec. using a 5,400 K color temperature light source through a W-26 filter for red light exposure, a No. 99 filter for green light exposure and a No. 98 filter for blue light exposure, employing Wratten filters produced by Eastman Kodak Company, after which the foregoing standard color development processing was conducted to prepare the color developed samples of each color separation exposure.

### Preparation of Characteristic Curves

Density of each of the samples prepared above, which were color-developed after exposure of white light and each color separated light was measured with red light, green light and blue light using a transmission densitometer, model 310T manufactured by X-Rite Inc. The characteristic curves consisting of the exposure amount (Log E) in the horizontal axis and the density (D) in the vertical axis were obtained.

### Measurement of Minimum Density

Density of each white light exposed sample in the unexposed region was referred to as the minimum density of the sample, and the obtained results are shown in Table 5.

TABLE 5

| | Minimum density | | | |
|---|---|---|---|---|
| Sample No. | R | G | B | Remarks |
| 101 | 0.22 | 0.46 | 0.65 | Comp. |
| 102 | 0.10 | 0.11 | 0.12 | Comp. |
| 103 | 0.11 | 0.12 | 0.12 | Inv. |
| 104 | 0.23 | 0.48 | 0.67 | Comp. |
| 105 | 0.22 | 0.47 | 0.66 | Comp. |
| 106 | 0.12 | 0.12 | 0.13 | Comp. |
| 107 | 0.23 | 0.48 | 0.68 | Inv. |
| 108 | 0.12 | 0.13 | 0.13 | Inv. |

Comp.; Comparative example
Inv.; This invention

### Measurement of Secondary Differential Values

In the characteristic curves of each sample of white light exposure, the point gamma values (ΔD/ΔLog E) were measured in intervals of ΔLog E 0.01, and the primary differential values were determined. These primary differential values were further differentiated to determine the secondary differential values. Further, a ratio (%) of regions exhibiting 0.05 or more of the secondary differential values were determined, and the obtained results are shown in Table 6.

TABLE 6

| | Regions of more than | | | |
|---|---|---|---|---|
| | 0.05 of secondary | | | |
| | differential values | | | |
| | (%) | | | |
| Sample No. | R | G | B | Remarks |
| 101 | 8.5 | 9.5 | 11.4 | Comp. |
| 102 | 10.1 | 11.5 | 13.2 | Comp. |
| 103 | 73.2 | 76.4 | 79.9 | Inv. |
| 104 | 8.0 | 8.0 | 9.5 | Comp. |
| 105 | 68.8 | 72.4 | 75.1 | Comp. |
| 106 | 8.5 | 10.5 | 11.5 | Comp. |
| 107 | 72.8 | 75.6 | 77.1 | Inv. |
| 108 | 73.7 | 77.4 | 80.2 | Inv. |

Comp.; Comparative example
Inv.; This invention

### Measurement of Color Separation γ/White Exposure γ

In the characteristic curves of the white light exposure samples and the color separation light exposure samples, the density point of the minimum density +0.30 and the density point of 1.5 of Log E of the exposure range from that point were connected by a straight line, and then the gradient of the line (tan θ) was determined and defined as a gamma value (a γ value). The ratio of γvalues of the white exposure samples (γWR, γWG and γWB) to γvalues of each color separation exposure samples (γR, γG and γB) was determined, the obtained results of which are shown in Table 7.

TABLE 7

| | Color separation γ/White | | | |
|---|---|---|---|---|
| | exposure γ | | | |
| Sample No. | γR/γWR | γG/γWG | γB/γWB | Remarks |
| 101 | 1.31 | 1.17 | 1.22 | Comp. |
| 102 | 1.29 | 1.16 | 1.20 | Comp. |
| 103 | 1.34 | 1.19 | 1.24 | Inv. |
| 104 | 1.03 | 1.03 | 1.02 | Comp. |
| 105 | 1.33 | 1.18 | 1.23 | Comp. |
| 106 | 1.03 | 1.02 | 1.02 | Comp. |
| 107 | 1.03 | 1.03 | 1.02 | Inv. |
| 108 | 1.02 | 1.02 | 1.02 | Inv. |

Comp.; Comparative example
Inv.; This invention

### Evaluation of Formed Images of each Sample

Samples 101-108 prepared as above were slit and perforated for normal 135 standard negative film, and loaded into a common camera to capture images of people and a color chart board produced by GretagMacbeth. Image capture was conducted under three conditions: under exposure (U), normal exposure (N) and over exposure (O).

Each of the captured image samples was treated with the foregoing standard color development processing, and image information recorded onto the development processed samples was read using a film scanner, being specifically a DUO Scan manufactured Agfa-Gevaert AG., providing image processing on a personal computer. After the enhancing process for image quality and color reproduction, the obtained image information was outputted onto glossy surface paper via an ink-jet “Photolike QP”, produced by Konica Corp., using a PM-7000 printer manufactured by Seiko Epson Corp. Image quality of the obtained printed images was evaluated using the following 5 step visual observation criteria by 4 persons of experience in image quality evaluation, and the averaged values were used for the results.

5: Images were extremely satisfactory, and an even texture was detected.

4: Images were satisfactory, and no observable defects were noted.

3: Sharpness, graininess, gradation and color reproduction were excellent.

2: Any of sharpness, graininess, gradation and color reproduction was unsatisfactory.

1: Images exhibited obvious defects.

In this invention, ranks 3-5 were evaluated as being practically acceptable levels. The obtained averaged results are shown below.

| Sample No. | Evaluated rank |
|---|---|
| 101 | 1.8 |
| 102 | 2.3 |
| 103 | 3.7 |
| 104 | 2.6 |
| 105 | 2.7 |
| 106 | 2.8 |
| 107 | 3.8 |
| 108 | 4.4 |

### Effects of the Invention

According to the present invention, it is possible to provide a silver halide color photographic light sensitive material for image capture which is easily read via a scanner for conversion to digital image information, providing a color image forming method to obtain high quality color images.

What is claimed is:

1. A silver halide color photographic light sensitive material for image capture comprising a transparent substrate having on one surface side thereof, a red light-sensitive layer unit, a green light-sensitive layer unit and a blue light-sensitive layer unit, each light-sensitive layer unit having at least 2 layers of the same spectral sensitivity having a different light sensitivity, and a specific photographic sensitivity of the light sensitive material is 50 or more,
wherein the light sensitive material produces an image after being exposed and being subjected to a development processing, each color image formed in the red sensitive layer unit, the green sensitive layer unit or the blue sensitive layer unit exhibits +0.05 or more secondary differential values in a region of more than 70% of a principal gradation portion in each characteristic curve of red, green and blue, and each transmission minimum density value of red light, green light and blue light is 0.15 or less.

2. The silver halide color photographic light sensitive material for image capture comprising a transparent substrate having on one surface side thereof, a red light-sensitive layer unit, a green light-sensitive layer unit and a blue light-sensitive layer unit, each light-sensitive layer unit having at least 2 layers of the same spectral sensitivity having a different light sensitivity, and a specific photographic sensitivity of the light sensitive material is 50 or more,
wherein the light sensitive material produces an image after being exposed and being subjected to a development processing, each color image formed in the red sensitive layer unit, the green sensitive layer unit and the blue sensitive layer unit exhibits +0.05 or more secondary differential values in more than 70% of a region of a principal gradation portion in each characteristic curve, and color separation exposure gradations of γR, γG and γB and white light exposure gradation of γWR, γWG and γWB fulfill all of the following formulas (1) to (3):
1.0≦γR/γWR≦1.05 Formula (1)
1.0≦γG/γWG≦1.05 Formula (2)
1.0≦γB/γWB≦1.05 Formula (3)
wherein γR, γG and γB are each red sensitive layer gradation at red light exposure, green sensitive layer gradation at green light exposure and blue sensitive layer gradation at blue light exposure respectively; γWR, γWG and γWB are each red sensitive layer gradation at white light exposure, green sensitive layer gradation at white light exposure and blue sensitive layer gradation at white light exposure respectively.

3. The silver halide color photographic light sensitive material for image capture comprising a transparent substrate having on one surface side thereof, a red light-sensitive layer unit, a green light-sensitive layer unit and a blue light-sensitive layer unit, each light-sensitive layer unit has at least 2 layers of the same spectral sensitivity having a different light sensitivity, and a specific photographic sensitivity of the material is 50 or more,
wherein the light sensitive material produces an image after being exposed and being subjected to a development processing, each color image formed in the red sensitive layer unit, the green sensitive layer unit and the blue sensitive layer unit exhibits a standard deviation σ of 0.01-0.05 obtained from exponential function matching in more than 70% of a region of a principal gradation portion in each characteristic curve of red light, green light and blue light.

4. A color image forming method for obtaining color prints from outputted digital images after the silver halide color photographic light sensitive material for image capture has been exposed and development processed, followed by digital image conversion,
wherein the light sensitive material produces an image after being exposed and being subjected to a development processing, each color image formed in the red sensitive layer unit, the green sensitive layer unit or the blue sensitive layer unit exhibits positive secondary differential values in not less than 70% of the region of the principal gradation portion in the characteristic curves, and digital image data conversion is conducted using a method comprising the steps of:
(i) providing shading correction, pixel sensitivity correction and dark current correction to the outputted signals in proportion to an amount of transmitted light, and (ii) converting the corrected signals to signals in proportion to image luminance using nonlinear conversion.
